(19) United States
(12) Patent Application Publication
(10) Pub. No.: US 2023/0159330 A1
(43) Pub. Date: May 25, 2023

(54) Apparatus and Method for Producing Synthesis Gas

(71) Applicant: Foundation Renewable Carbon Inc., Calgary (CA)

(72) Inventors: Terry Kemp, Calgary (CA); Qun Mao, Calgary (CA)

(21) Appl. No.: 18/048,801

(22) Filed: Oct. 21, 2022

Related U.S. Application Data
(60) Provisional application No. 63/281,428, filed on Nov. 19, 2021.

(51) Int. Cl. C01B 3/48; B01J 19/24; C01B 3/50; F02C 6/00

(52) U.S. Cl. CPC C01B 3/48; B01J 19/245; C01B 3/50; F02C 6/00; C01B 2203/0244; C01B 2203/0233; C01B 2203/0283; C01B 2203/0475; C01B 2203/1058; C01B 2203/1241; C01B 2203/062; C01B 2203/061; B01D 53/047

(57) ABSTRACT

An apparatus for producing synthesis gas (syngas) is provided. The apparatus includes a hub, including an autothermal dry reforming of methane apparatus, configured to receive CO₂ and O₂, and configured to produce a first stream of syngas with low a H₂/CO mole ratio; an autothermal steam reforming of methane apparatus, configured to receive steam and O₂, and configured to produce a second stream of syngas with a high H₂/CO mole ratio; an H₂ separation apparatus, configured to receive H₂ and CO₂, and coupled to the autothermal dry reforming of methane apparatus to deliver CO₂ thereto; and a reactor for converting CO to H₂ using a water-gas shift reaction, coupled to the autothermal steam reforming of methane apparatus to receive the second stream of syngas, and coupled to the H₂ separation apparatus to deliver a stream of H₂ and CO₂ thereto. A method for producing synthesis gas is provided. The method includes configuring an autothermal dry reforming of methane apparatus to receive CO₂ from industrial emission sources and an H₂ separation apparatus, which receives H₂ and CO₂ from a water gas shift reactor fed with a portion of the second stream of syngas from an autothermal steam reforming of methane apparatus.

### TECHNICAL FIELD

The present invention relates to apparatus and methods for producing synthesis gas (syngas) in general, and apparatus and methods that use CO₂ as feedstock to produce synthesis gas and hydrogen for polygeneration in particular.

### BACKGROUND

Carbon dioxide (CO₂) is a greenhouse gas that contributes to global warming. One method, referred to as carbon capture and storage may be used to reduce CO₂ emissions from industrial large point sources to the atmosphere may include capturing CO₂ and storing it underground in geological formations. In one embodiment, CO₂ captured, for example, in industrial facilities, may be compressed, liquefied, and transported via pipeline. Such a method gives rise to significant expense, among other disadvantages.

Syngas, or synthesis gas, is a gas mixture that may include hydrogen (H₂) and carbon monoxide (CO), which can be used as fuel gas or as feedstock to produce liquid fuels, chemicals, and/or petrochemicals. The most common technology for the production of syngas is steam methane reforming (SMR), in which methane or natural gas may react with steam (water vapor) to produce hydrogen and carbon monoxide, which may be represented by the following equation:

CH₄+H₂O [symbol] 3H₂+CO

Currently available apparatus and methods for CO₂ capture and utilization (CCU) may include CO₂ being used as a raw material, which may produce liquid fuels and petrochemical commodities. Existing methods and apparatus related to CO₂ utilization are constrained such that they cannot be adopted in industry worldwide on large scales. Accordingly, there is a demand for apparatus and methods that use greenhouse gasses as input materials to improve their utility and reduce their negative environmental impacts.

### SUMMARY OF INVENTION

In accordance with a broad aspect of the present invention, there is provided an apparatus for producing synthesis gas, comprising a hub, including an autothermal dry reforming of methane apparatus, configured to receive CO₂ and O₂, and configured to produce a first stream of syngas with a H₂/CO mole ratio between 0.5:1 and 1:1; an autothermal steam reforming of methane apparatus, configured to receive steam and O₂, and configured to produce a second stream of syngas with a H₂/CO mole ratio between 2.0:1 and 2.5:1; an H₂ separation apparatus, configured to receive H₂ and CO₂, and coupled to the autothermal dry reforming of methane apparatus to deliver CO₂ thereto; and a reactor for converting CO to H₂ using a water-gas shift reaction, coupled to the autothermal steam reforming of methane apparatus to receive the second stream of syngas therefrom, and coupled to the H₂ separation apparatus to deliver a stream of H₂ and CO₂ thereto.

In accordance with another broad aspect of the present invention, there is provided a method for producing synthesis gas, comprising configuring an autothermal dry reforming of methane apparatus to receive CO₂ from one or more industrial emission sources and/or an H₂ separation apparatus, which receives H₂ and CO₂ from a water gas shift reactor fed with syngas generated in an autothermal steam reforming of methane apparatus.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

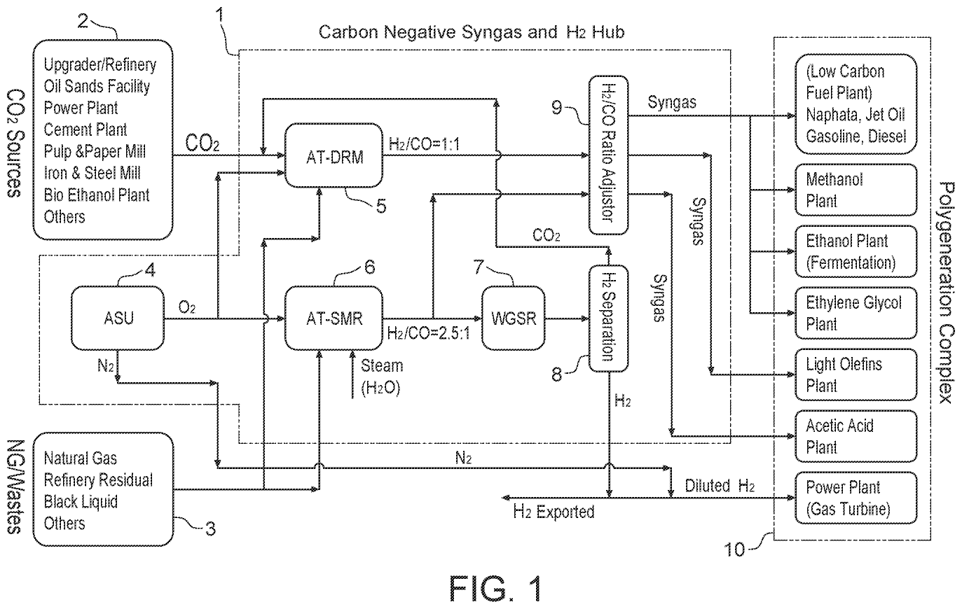

(a) FIG. 1 is a schematic diagram of an apparatus and method for producing synthesis gas according to one embodiment of the present invention; and

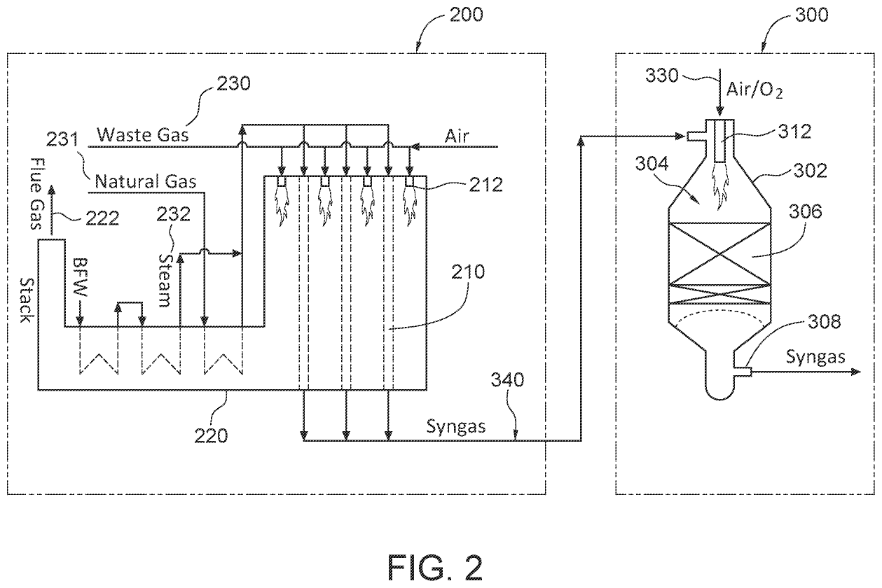

(b) FIG. 2 is a schematic diagram of a steam methane reforming apparatus and an autothermal reformer apparatus used in combination according to another embodiment of the present invention.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

A method and apparatus for producing syngas are provided. In one embodiment, the method and apparatus may include autothermal dry reforming of methane (AT-DRM) and autothermal steam methane reforming (AT-SMR) used in combination. An autothermal dry reforming of methane apparatus may produce a low H₂/CO mole ratio (for example, in an approximate range of 0.5:1 to 1:1, such as 1:1) syngas stream, and an autothermal steam reforming of methane apparatus may produce a high H₂/CO mole ratio (for example, in an approximate range of 2.0:1 to 2.5:1, such as 2.5:1) syngas stream. The syngas of different desired H₂/CO mole ratios from approximately 1:1 to approximately 2.5:1 may be obtained by mixing these two streams with adjustable flowrates from autothermal dry reforming of methane and autothermal steam methane reforming apparatus.

In one embodiment, a water-shift gas reactor (WGSR) unit may receive a portion of high H₂/CO ratio syngas from an autothermal steam reforming of methane apparatus. Steam (water vapor) may be added as a reactant, and additional hydrogen may be obtained via water-gas shift reaction. CO₂ may also be generated in the water-shift gas reactor unit. The outlet stream from the water-shift gas reactor unit may include a mixture of hydrogen and CO₂. Hydrogen may be separated from the mixture, for example via pressure swing adsorption (PSA) and/or membrane filtration. Hydrogen may be added to the syngas stream from the autothermal dry reforming of methane apparatus to increase the H₂/CO ratio, and/or as fuel for power generation. Hydrogen, for example green and/or blue hydrogen, may then be shipped and/or used for other applications. CO₂ from the H₂ separation apparatus may be recycled back to the autothermal dry reforming of methane unit as a feedstock.

The method and apparatus provided herein may also include an air separation apparatus. Oxygen from the air separation apparatus may be supplied to either or both of the autothermal dry reforming of methane apparatus and the autothermal steam reforming of methane apparatus for the partial oxidation of natural gas and/or other hydrocarbon fuels in the autothermal reformers.

A hub for syngas and/or hydrogen production, which may be carbon emission negative, is provided. The hub may receive CO₂, for example from external industry sources, including but not limited to sources such as a crude oil upgrader and refinery, a power plant, an oil sands facility, a cement plant, an iron and steel mill, a pulp and paper mill, a bio ethanol plant, or other chemical processes or facilities. In addition to CO₂, natural gas and/or renewable natural gas may be one of the feedstocks for either or both of the autothermal dry reforming of methane apparatus and the autothermal steam reforming of methane apparatus. Natural gas may be a fuel gas for partial oxidation in either or both of the autothermal dry reforming of methane apparatus and autothermal steam reforming of methane apparatus. Other sources of hydrocarbon, such as upgrader and refinery residuals, black liquid from pulp and paper mills, and/or renewable oils, may also be used as fuel for partial oxidation to provide heat for the autothermal reforming in either or both autothermal dry reforming of methane apparatus and autothermal steam reforming of methane apparatus.

A method is provided for using carbon dioxide (CO₂), which may originate from industrial large point sources, as raw material to generate syngas (H₂+CO) and hydrogen (H₂). A process and system is provided that may use CO₂ as feedstock, optionally with other hydrocarbons and/or renewable carbon sources and oxygen, to produce selected H₂/CO ratio syngas and hydrogen for the polygeneration of low carbon intensity liquid fuels and petrochemical commodities.

The method may include integrating a method and/or apparatus for autothermal dry reforming of methane and a method and/or apparatus for autothermal steam methane reforming. An autothermal dry reforming of methane apparatus may produce a first stream with a low H₂/CO ratio syngas while an autothermal steam reforming of methane apparatus may produce a second stream with a high H₂/CO ratio syngas. Syngas with desired H₂/CO ratios may be obtained by mixing the first stream and second stream (i.e., low and high H₂/CO ratio streams) from the autothermal dry reforming of methane and autothermal steam reforming of methane units to create a third stream. The third stream may be distributed to a polygeneration complex, for example, to be used for the production of low carbon intensity liquid fuels and petrochemical commodities. Hydrogen may be generated via a water-gas shift reactor, which may be fed with a portion of syngas from the autothermal steam reforming of methane unit. In one embodiment, the method may use a syngas/hydrogen generation hub apparatus and a polygeneration complex apparatus. The method may have carbon-negative emissions characteristics. There is a demand in the market for such a method, for example, as it may contribute to efficient carbon capture and utilization and thereby reduce greenhouse gas (GHG) emissions.

There is provided a method and apparatus for syngas and/or hydrogen generation, which may include supplying syngas with selected H₂/CO ratios and hydrogen which may be used for the polygeneration of liquid fuels and petrochemical commodities, which may advantageously be of relatively low carbon intensity.

Steam methane reforming is an endothermic reaction, consuming heat, with reaction heat of approximately ΔHr=206 kJ/mol. With reference to FIG. 2, a steam methane reformer apparatus 200 may include a plurality (for example, hundreds of) vertically hanging tubes 210 in a furnace 220 with a nickel-based catalyst that may be packed inside the tubes, which may be heated externally within the furnace by firing (e.g., via burners 212 with fuel gas (e.g., waste gas 230 and/or natural gas 213) and producing CO₂ emissions in a flue gas stream 222 from the furnace 220. Natural gas 231, which may include methane and steam 232 (water vapor), may flow into the reformer tubes 210. A reforming reaction may occur in the presence of a catalyst at temperatures ranging from approximately 700 to 1000° C. and pressures ranging from approximately 3 to 30 bar. A large volume of fuel gas may be burned in the reformer furnace 220, in order to provide external heat for the endothermic reaction in the tubes 210. The flue gas 222 containing CO₂ may be vented to the atmosphere.

Syngas may be used for the production of synthetic liquid fuels and petrochemicals, such as synthetic diesel, gasoline, jet oil, methanol, ethanol, methyl formate, dimethyl carbonate, acetic acid, formic acid, and light olefins; however, there may be an H₂/CO ratio requirement for the syngas as feedstock for the production of these materials. For example, H₂/CO ratio in the syngas for liquid fuel synthesis via a Fisher-Tropsch synthesis reaction is in the approximate range of 1.5 to 2.0. Hydrogen may be used, for example, in crude oil upgraders and refineries for hydrocracking and hydrotreatment of oil distillates or as a direct fuel source. So called grey, blue, and green hydrogen may be dependent on and characterized by the source input of the carbon and handling of the CO₂ byproducts.

When coupled with a steam methane reforming apparatus and/or dry reforming of methane apparatus, a water-gas shift reactor apparatus may be used for H₂ production, and/or may be used to produce additional free hydrogen or adjust the H₂/CO ratio as may be used by (and possibly required for) additional downstream processes. The shift reaction process may be represented by the following equation (also referred to as the water-gas shift reaction equation):

CO+H₂O [symbol] CO₂+H₂

With reference to FIG. 2, for the production of hydrogen, ammonia (NH₃) and methanol (CH₃OH), the steam methane reforming apparatus 200 may be used as a primary reformer. A secondary reformer may also be adapted to increase the syngas generation and adjust the hydrogen to nitrogen ratio. The secondary reformer may include an autothermal reformer (ATR) 300. For clarity, the autothermal reformer is not necessarily solely an autothermal reaction, since the process stream entering into the autothermal reformer is hot syngas with unreacted methane from the upstream primary reformer (e.g., the steam methane reforming apparatus). A stream including one or more of air from the atmosphere, pure oxygen, and natural gas may be added and/or burned (e.g., via burners) in the autothermal reformer, which may provide additional heat for the reforming reaction of the methane in the syngas stream 340 from the steam methane reforming apparatus 200, upstream of the autothermal reformer 300.

An autothermal reformer 300 may include a refractory-lined pressure vessel 302, which may contain a combustion chamber 304 in a first section and a set of one or more catalyst beds 306 in a second section. The first section may be arranged above the second section. A stream 330 including one or more of natural gas, air from the atmosphere, and/or pure oxygen may be introduced from a burner 312, which may be positioned on the top of the vessel, into the combustion zone. In the combustion zone, the natural gas may be burned, thereby liberating heat and raising the temperature of the process stream from the primary reformer. A reforming reaction may take place in the catalyst bed, creating reformate gases such as syngas. The reformate gases may leave the autothermal reformer apparatus through a nozzle 308. The nozzle may be positioned at the bottom of the vessel.

A modular or standalone autothermal reformer may provide a high conversion autothermal reforming for syngas generation, reducing or eliminating the need and/or utility of an externally-heated multiple tubular steam methane reforming apparatus. Stand-alone autothermal reformer apparatus may include a combination of methane partial oxidation (POX) in a chamber and steam methane reforming in a catalytic reactor. It may include autothermal steam methane reforming apparatus. There may be less, possibly substantially zero, CO₂ vented to the atmosphere from the autothermal steam reforming of methane apparatus, at least in part because the heat required for the steam reforming of methane is supplied via a partial oxidation reaction. The H₂/CO mole ratio in the syngas generated by autothermal steam reforming of methane apparatus is approximately 2.5:1. It is represented by the following equation:

4CH₄+O₂+20H₂O→10H₂+4CO

Instead of steam (H₂O), CO₂ can be used as feedstock to react with methane (CH₄) for syngas generation, which is dry reforming of methane (DRM) or CO₂ reforming of methane. The dry reforming of methane reaction may be represented by the following equation:

CO₂+CH₄→2H₂+2CO

Similar to steam methane reforming, dry reforming of methane is a strongly endothermic reaction as well, consuming heat, approximately ΔHr=247 kJ/mol, requiring external heat for the reforming reaction taking place in the presence of catalyst packed in the tubular reactor. The main difference, when compared to steam methane reforming, is the tendency of coking or carbon forming on the surface of the catalyst, resulting in the deactivation of the catalyst.

Interest in dry reforming of methane technology has increased in recent decades as it consumes two greenhouse gasses (CO₂ and CH₄) as raw material to produce syngas. However, CO₂ emissions may remain in the flue gas from the reformer furnace since dry reforming of methane needs external heating, as may also be the case for steam methane reforming technology.

Same as with autothermal steam reforming of methane apparatus, dry reforming of methane can be autothermally heated via partial oxidation of methane or other hydrocarbon fuels, which is autothermal dry reforming of methane, represented by the following equation:

2CH₄+O₂+CO₂→3H₂+3CO+H₂O

The H₂/CO mole ratio in the syngas generated by autothermal dry reforming of methane apparatus is approximately 1:1. At present, there is no industrial autothermal dry reforming of methane application, which may be due to the catalyst being deactivated during operation, and/or low H₂/CO ratio in the syngas, which has limited application for producing chemical or petrochemical products downstream. There is a demand in the market for autothermal dry reforming of methane catalysts with improved stability.

Dry reforming of methane apparatus, and autothermal dry reforming of methane apparatus, may consume two greenhouse gases as raw material, and may produce relatively low H₂/CO ratio syngas with limited application for downstream chemical or petrochemical synthesis. As discussed above, another potential disadvantage of dry reforming of methane is that while using CO₂ as feedstock, it emits CO₂ via the reformer furnace stack, at least partly because external heating is required for the dry reforming of methane reaction. On the other hand, autothermal dry reforming of methane provides an approach of utilizing CO₂ at an autothermal condition, avoiding external heating with CO₂ emission in the flue gas.

In one embodiment, the apparatus and methods provided herein may be characterized as a carbon negative syngas and hydrogen generation hub, which combines autothermal dry reforming of methane apparatus and autothermal steam reforming of methane apparatus together to consume the CO₂ from industrial sources for the generation of hydrogen and syngas with desired H₂/CO ratios for the polygeneration of liquid fuels and petrochemical commodities. Different syngas for liquid fuels/petrochemicals production may require different H₂/CO mole ratios, mostly varying from approximately 1:1 to approximately 2:1. For example, the ratio of H₂/CO for syngas to liquid fuel reaction, methanol, and ethanol is in the range of approximately 1.5:1 to approximately 2:1, and for the syngas to light olefins production is approximately 1.5:1. Each product in the polygeneration method and apparatus may have different H₂/CO ratios. Excess hydrogen may be used as fuel for the hub and/or the polygeneration complex.

Dry reforming of methane, and autothermal dry reforming of methane, are promising technologies since they consume two greenhouse gases as raw material. Their product may be low H₂/CO ratio syngas with limited application for downstream chemical and petrochemical synthesis, and dry reforming of methane emits CO₂ via the reformer furnace stack since external heating for the dry reforming of methane reaction is required. There remains a demand for processes or methods which may use CO₂ as raw material to produce hydrogen and particularly syngas with desired H₂/CO ratios for the polygeneration of value-added liquid fuels and petrochemical commodities.

CO₂ may be used as a valuable raw material. The methods and apparatus described herein may use carbon dioxide (CO₂) as feedstock to generate syngas and hydrogen for polygeneration of low carbon intensity liquid fuels and high value petrochemical commodities and also use recycled CO₂.

With reference to FIG. 1, an apparatus and method of using CO₂ as a raw material to produce syngas with desired H₂/CO ratios and hydrogen is provided for polygeneration of low carbon intensity liquid fuels and petrochemical commodities, integrating autothermal dry reforming of methane and autothermal steam methane reforming.

According to one embodiment, there is a carbon negative syngas and hydrogen hub 1, an industrial CO₂ source 2; a natural gas and/or hydrocarbon waste source 3, an air separation apparatus 4; an autothermal dry reforming of methane unit 5; an autothermal steam methane reforming unit 6; a water-gas shift reaction unit 7; an H₂ separation apparatus 8; a H₂/CO ratio adjustor 9; and a polygeneration complex 10.

As illustrated in FIG. 1, the carbon negative syngas and hydrogen hub 1 may include air separation apparatus 4, autothermal dry reforming of methane unit 5, autothermal steam methane reforming unit 6, water-gas shift reaction unit 7, H₂ separation apparatus 8, and H₂/CO ratio adjustor 9. The syngas and hydrogen hub 1 receives CO₂ (for example, in large quantities) from one or more industrial facilities 2, in which CO₂ can be captured and stored, or delivered, as a gas or dense liquid, for example via pipeline.

One or more autothermal dry reformers in the autothermal dry reforming of methane unit 5 is configured to receive CO₂ from facility 2 as feedstock to react with methane in the natural gas from source 3 (such as a pipeline) in the presence of soot-free novel nickel-based catalysts at temperatures in an approximate range of 900 to 1000° C. and pressure of approximately 3 to 30 bar. This is a dry reforming of methane reaction, which is represented by CO₂+CH₄→2H₂+2CO. It is a strongly endothermic reaction, with reaction heat of approximately ΔHr=247 kJ/mol. The heat required for the dry reforming reaction is provided by partial oxidation or combustion of natural gas from a pipeline if conventional type autothermal reformers are used; or crude oil upgrader/refinery residuals, and/or black liquid from pulp and paper mills, and/or other liquid or solid hydrocarbon wastes may be used as fuels if an autothermal reformer (ATR) with ash and/or slag discharge nozzles are provided, for example, at the bottom of the partial oxidation chamber in the ATR. Substantially pure oxygen may be fed to the ATR for the partial oxidation reaction. The overall partial oxidation and dry reforming reaction may be represented by equation 2CH₄+O₂+CO₂→3H₂+3CO+H₂O. Syngas with a H₂/CO mole ratio of approximately 0.5:1 to 1:1 may be generated in this autothermal dry reforming of methane (AT-DRM) unit.

Instead of feeding with CO₂, one or more autothermal steam reformers in the autothermal steam reforming of methane (AT-SMR) unit 6 are fed with steam (water vapor), which may react with methane in the natural gas from source 3 (e.g., a pipeline) in the presence of nickel-based catalysts at temperatures ranging from approximately 700 to 1000° C. and pressure of approximately 3 to 30 bar. This is steam reforming of methane reaction, which is represented by CH₄+H₂O→3H₂+CO. Similar to dry reforming of methane, it is a strongly endothermic reaction, with reaction heat ΔHr=206 kJ/mol. The heat required for the steam methane reforming reaction is provided by partial oxidation or combustion of natural gas, for example, if conventional type autothermal reformers are used; or crude oil upgrader/refinery residuals, and black liquid from pulp and paper mills, or other liquid or solid hydrocarbon wastes may be used as fuels. Oxygen is fed to the autothermal for the partial oxidation reaction. The overall partial oxidation and steam reforming reaction may be represented by 4CH₄+O₂+2H₂O→10H₂+4CO. Syngas with an H₂/CO mole ratio of approximately 2.0:1 to 2.5:1 may be generated in such an embodiment of the autothermal steam reforming of methane unit.

Substantially pure oxygen, for example, with oxygen concentration not less than 95% (mole) may be generated in the air separation apparatus 4. By-product nitrogen of the air separation apparatus may be used to dilute the hydrogen feeding to the gas turbine in the polygeneration complex 10. The technology of air separation apparatus can include, for example, one or more of cryogenic air separation, pressure swing adsorption and membrane filtration.

Conventional dry reforming of methane apparatus and steam methane reforming apparatus may have hundreds of vertical tubular reactors hanging in a furnace that are heated externally. By contrast, autothermal dry reforming of methane and autothermal steam reforming of methane apparatus may be heated by the partial oxidation hot gases. Accordingly, there may be no flue gas and no CO₂ emission resulting from natural gas combustion with the air in the reformer furnace. Autothermal dry reforming of methane and autothermal steam reforming of methane units may be arranged in parallel in the syngas and hydrogen hub 1.

There may be two pipe manifolds in the H₂/CO adjustor 9. A first pipe manifold may receive low H₂/CO mole ratio (approximately 0.5:1 to 1:1, for example 1:1) syngas from the autothermal dry reforming of methane unit 5. A second pipe manifold may receive high H₂/CO mole ratio (approximately 2.0:1 to 2.5:1, for example 2.5:1) syngas from the autothermal steam reforming of methane apparatus 6. There may be multiple flow control valves installed on these two manifolds, for example in pairs or other arrangements. The low H₂/CO ratio syngas and the high H₂/CO ratio syngas may flow through the control valves separately, and be mixed together in separate pipes with different H₂/CO ratios. These mixed syngas streams with desired H₂/CO ratios may be distributed to the different plants downstream in the polygeneration complex for the production of low carbon intensity liquid fuels and high value petrochemical commodities.

A portion of syngas, depending on the polygeneration complex requirements and external hydrogen demands, from autothermal steam reforming of methane unit 6 may flow to the water-gas shift reaction unit 7. The carbon monoxide (CO) in the syngas may react with steam (water vapor) in the presence of catalysts, and then be converted to hydrogen with by-product CO₂. This reaction may be represented by equation CO+H₂O [symbol] CO₂+H₂. Hydrogen may be separated in the H₂ separation apparatus 8, and CO₂ may be recycled to the autothermal dry reforming of methane unit 5 as feedstock to produce syngas.

Hydrogen diluted with nitrogen from the air separation apparatus 4 may flow to the power plant in the polygeneration complex, for example, to feed gas turbine for electricity generation. There may be no CO₂ emission from the turbine duct since the product of hydrogen combustion is water vapor, with the reaction represented by 2H₂+O₂→2H₂O. A portion of electricity generated by the gas turbine may be for self-use in the syngas/hydrogen hub and the polygeneration complex; the rest may be exported as low carbon intensity electricity for third party use. Low carbon intensity hydrogen (commonly referred to as blue or green hydrogen) may also be delivered to customers.

The polygeneration complex 10 may include, for example, one or more of a low carbon intensity liquid fuels plant, a methanol plant, an ethanol plant, an ethylene glycol pant, a formic acid plant, an acetic acid plant, a light olefins plant, and a power plant. The carbon negative syngas and hydrogen hub may be used to improve the efficiency of the use of CO₂ from large industrial sources and minimize the carbon footprint of the polygeneration of liquid fuels and petrochemicals. The whole process including the syngas/hydrogen generation and the polygeneration may be a carbon negative emission system.

The apparatus and method may include a negative carbon emission syngas and hydrogen generation hub 1, which may supply syngas with desired H₂/CO ratios for the polygeneration of low carbon intensity synthetic liquid fuels and petrochemical commodities, and provides hydrogen for power generation or other application.

The syngas and hydrogen hub may include an autothermal dry reforming of methane unit 5, an autothermal steam methane reforming unit 6, an air separation apparatus 4, a water-gas shift reaction unit 7, a hydrogen separation apparatus 8, and an H₂/CO ratio adjustor 9.

In use, the autothermal dry reforming of methane unit may receive a stream of CO₂ and/or natural gas and use same to generate syngas with an approximate 1:1 H₂/CO mole ratio. The autothermal dry reforming of methane unit fed with pure oxygen from the air separation apparatus and natural gas from pipeline or crude oil upgrader/refinery residuals, black liquid from pulp and paper mills, or other hydrocarbon wastes for partial oxidation to provide heat for the CO₂ dry reforming of methane.

The autothermal steam reforming of methane unit may use natural gas to react with steam (water vapor) to generate syngas with an approximate 2.5:1 H₂/CO mole ratio. The autothermal steam reforming of methane apparatus fed with pure oxygen from the air separation apparatus and natural gas from pipeline or crude oil upgrader/refinery residuals, black liquid from pulp and paper mills, or other hydrocarbon sources (for example, waste sources) for partial oxidation may be used to provide heat for the steam methane reforming.

The autothermal dry reforming of methane unit and the autothermal steam reforming of methane unit in the syngas and hydrogen hub may be arranged in parallel. The syngas from the autothermal dry reforming of methane unit with low H₂/CO ratio and the syngas from the autothermal steam reforming of methane unit with high H₂/CO ratio may each output streams of fluid to the H₂/CO ratio adjustor 9. Adjustor 9 may include one or more mixers to adjust the H₂/CO ratios of the mixed syngas. The streams of mixed syngas with various desired H₂/CO ratios are distributed to different plants of the polygeneration complex 10 for the production of low carbon intensity liquid fuels and petrochemical products.

A portion of syngas from the autothermal steam reforming of methane unit may go to the water-gas shift reactor unit 7. The water-gas shift reactor unit 7 may convert CO in the syngas to H₂, which is represented by the following equation:

CO+H₂O [symbol] CO₂+H₂

The H₂ separation apparatus 8 can include a pressure swing adsorption and/or membrane filtration process, which may separate H₂ in the process stream from the water-gas shift reactor unit. H₂ may be used as fuel gas for power generation, or delivered to industrial customers. CO₂ separated from the process stream via the H₂ separation apparatus (such as a partial swing absorption or membrane filtration apparatus) may be recycled back to the autothermal dry reforming of methane unit as feedstock for dry reforming of methane. Hydrogen from the H₂ separation apparatus 8 may be delivered to the H₂/CO adjuster 9, for example, to increase the H₂/CO ratio for one of the syngas streams to be used as feedstock for polygeneration of petrochemicals.

The capacities of both autothermal dry reforming of methane and autothermal steam reforming of methane units may be designed to maximize the utilization of CO₂ from industrial sources and supply syngas with various desired H₂/CO ratios for downstream polygeneration of low carbon intensity liquid fuels and petrochemicals.

The autothermal dry reforming of methane unit in the syngas and hydrogen generation hub may be replaced with a specially designed dry reforming of methane unit, which may be externally heated by electricity. The electricity used for dry reforming of methane heating can be, for example, renewable energy, such as solar-, wind-, and hydro-electric energy.

Conventional autothermal reformers with mechanic configuration similar to the conventional secondary reformers, such as those used in the ammonia and methanol plants, can be provided in, and/or adapted for use in, the autothermal dry reforming of methane and autothermal steam reforming of methane units. These conventional autothermal reformers may, for example, comprise a combustion chamber in an upper section and a catalyst bed in a bottom section of a closed pressure vessel. The burner may, for example, be installed on the top of the vessel with natural gas as the fuel gas for combustion or partial oxidation to provide heat for the methane reforming reaction in the catalyst bed at the bottom of the vessel.

In the autothermal reformer, instead of natural gas, or in addition, other elements may be used for partial oxidation to provide heat for the CO₂ dry reforming and steam reforming of methane, such as liquid and/or solid hydrocarbon waste, including crude oil upgrader/refinery residuals, petroleum coke, black liquid from pulp and paper mills, animal derived oil, etc. Ash or slag may be removed via the discharge nozzle at the bottom of the autothermal reformer.

The by-product nitrogen of the air separation apparatus in the syngas and hydrogen hub may be used to dilute the hydrogen fed to the hydrogen gas turbine for power generation in the polygeneration complex. There may be no CO₂ emission in the flue gas from the hydrogen gas turbine, since the product of hydrogen combustion is water vapor, represented by equation:

2H₂+O₂→2H₂O

An air separation apparatus nitrogen byproduct may also be used as a cold refrigerant for other applications or for low carbon fertilizer manufacturing, when combined with blue and/or green hydrogen that may be generated from the complex.

The polygeneration complex may include, for example, one or more of a liquid fuels plant, a methanol plant, an ethanol plant, an acetic acid plant, an ethylene glycol, a dimethyl carbonate (DMC) plant, a light olefins plant, and a power plant. These plants and their products are selected and designed to match the production capacity of the syngas and hydrogen hub, so as to improve the utilization efficiency of CO₂, and reduce the carbon intensities of liquid fuels via CO₂ negative emission offsetting and CO₂ credits of the co-production of petrochemical commodities.

### Clauses

Clause 1. An apparatus for producing synthesis gas, comprising: a hub, including an autothermal dry reforming of methane apparatus, configured to receive CO₂ and O₂, and configured to produce a first stream of syngas with a H₂/CO mole ratio between 0.5:1 and 1:1; an autothermal steam reforming of methane apparatus, configured to receive steam and O₂, and configured to produce a second stream of syngas with a H₂/CO mole ratio between 2.0:1 and 2.5:1; an H₂ separation apparatus, configured to receive H₂ and CO₂, and coupled to the autothermal dry reforming of methane apparatus to deliver CO₂ thereto; and a reactor for converting CO to H₂ using a water-gas shift reaction, coupled to the autothermal steam reforming of methane apparatus to receive the second stream of syngas therefrom, and coupled to the H₂ separation apparatus to deliver a stream of H₂ and CO₂ thereto.

Clause 2. The apparatus of any one or more of clauses 1-14, wherein: the hub further comprises an air separation apparatus; the autothermal dry reforming of methane apparatus is coupled to the air separation apparatus to receive a first stream of O₂ therefrom; and the autothermal steam reforming of methane apparatus is coupled to the air separation apparatus to receive a second stream of O₂ therefrom.

Clause 3. The apparatus of any one or more of clauses 1-14, wherein: the hub further comprises an H₂/CO ratio adjuster, coupled to the autothermal dry reforming of methane apparatus to receive the first stream of syngas therefrom, coupled to the autothermal steam reforming of methane apparatus to receive the second stream of syngas therefrom, coupled to the H₂ separation apparatus to receive a stream of H₂ therefrom, having at least one mixer including a manifold having one or more valves.

Clause 4. The apparatus of any one or more of clauses 1-14, further comprising: a CO₂ source coupled to the autothermal dry reforming of methane apparatus for delivering CO₂ to the autothermal dry reforming of methane apparatus.

Clause 5. The apparatus of any one or more of clauses 1-14, further comprising: the autothermal dry reforming of methane apparatus and the autothermal steam reforming of methane apparatus each being configured to receive natural gas.

Clause 6. The apparatus of any one or more of clauses 1-14, further comprising: a fuel source coupled to each of the autothermal dry reforming of methane apparatus and the autothermal steam reforming of methane apparatus for delivering a fuel stream of fluid to the autothermal dry reforming of methane apparatus and the autothermal steam reforming of methane apparatus.

Clause 7. The apparatus of any one or more of clauses 1-14, wherein the fuel source includes one or more of a natural gas source and a hydrocarbon waste source.

Clause 8. The apparatus of any one or more of clauses 1-14, further comprising at least one of: a gas turbine power plant, coupled to the air separation apparatus to receive N₂ therefrom, and coupled to the H₂ separation apparatus to receive H₂ therefrom; and a nitrogen fertilizer plant, and coupled to the air separation apparatus to receive N₂ therefrom, and coupled to the H₂ separation apparatus to receive H₂ therefrom.

Clause 9. The apparatus of any one or more of clauses 1-14, further comprising at least one of: a synthetic liquid fuel plant coupled to the H₂/CO ratio adjuster to receive syngas therefrom, a methanol plant coupled to the H₂/CO ratio adjuster to receive syngas therefrom, an ethanol plant coupled to the H₂/CO ratio adjuster to receive syngas therefrom, an ethylene glycol plant coupled to the H₂/CO ratio adjuster to receive syngas therefrom, a light olefins plant coupled to the H₂/CO ratio adjuster to receive syngas therefrom, and an acetic acid plant coupled to the H₂/CO ratio adjuster to receive syngas therefrom.

Clause 10. The apparatus of any one or more of clauses 1-14, wherein the autothermal dry reforming of methane apparatus includes an autothermal reformer, the autothermal reformer comprising a partial oxidation reactor and a catalytic reformer.

Clause 11. The apparatus of any one or more of clauses 1-14, wherein the catalytic reformer includes a nickel-based CO₂ dry reforming catalyst.

Clause 12. The apparatus of any one or more of clauses 1-14, wherein the autothermal steam reforming of methane apparatus includes an autothermal reformer, the autothermal reformer comprising a partial oxidation reactor and a catalytic reformer.

Clause 13. The apparatus of any one or more of clauses 1-14, wherein the catalytic reformer includes a nickel-based steam methane reforming catalyst.

Clause 14. A method for producing syngas, comprising: configuring an autothermal dry reforming of methane apparatus to receive CO₂ from one or more industrial emission sources and an H₂ separation apparatus, which receives H₂ and CO₂ from a water gas shift reactor fed with syngas generated in an autothermal steam reforming of methane apparatus.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. An apparatus for producing synthesis gas, comprising:
a hub, including
an autothermal dry reforming of methane apparatus,
configured to receive CO₂ and O₂, and
configured to produce a first stream of syngas with a H₂/CO mole ratio between 0.5:1 and 1:1;
an autothermal steam reforming of methane apparatus,
configured to receive steam and O₂, and
configured to produce a second stream of syngas with a H₂/CO mole ratio between 2.0:1 and 2.5:1;
an H₂ separation apparatus,
configured to receive H₂ and CO₂, and
coupled to the autothermal dry reforming of methane apparatus to deliver CO₂ thereto; and
a reactor for converting CO to H₂ using a water-gas shift reaction,
coupled to the autothermal steam reforming of methane apparatus to receive the second stream of syngas therefrom, and
coupled to the H₂ separation apparatus to deliver a stream of H₂ and CO₂ thereto.

2. The apparatus of claim 1, wherein:
the hub further comprises an air separation apparatus;
the autothermal dry reforming of methane apparatus is coupled to the air separation apparatus to receive a first stream of O₂ therefrom; and
the autothermal steam reforming of methane apparatus is coupled to the air separation apparatus to receive a second stream of O₂ therefrom.

3. The apparatus of claim 1, wherein:
the hub further comprises an H₂/CO ratio adjuster,
coupled to the autothermal dry reforming of methane apparatus to receive the first stream of syngas therefrom,
coupled to the autothermal steam reforming of methane apparatus to receive the second stream of syngas therefrom,
coupled to the H₂ separation apparatus to receive a stream of H₂ therefrom, having at least one mixer including a manifold having one or more valves.

4. The apparatus of claim 1, further comprising:
a CO₂ source coupled to the autothermal dry reforming of methane apparatus for delivering CO₂ to the autothermal dry reforming of methane apparatus.

5. The apparatus of claim 1, further comprising:
the autothermal dry reforming of methane apparatus and the autothermal steam reforming of methane apparatus each being configured to receive natural gas.

6. The apparatus of claim 1, further comprising:
a fuel source coupled to each of the autothermal dry reforming of methane apparatus and the autothermal steam reforming of methane apparatus for delivering a fuel stream of fluid to the autothermal dry reforming of methane apparatus and the autothermal steam reforming of methane apparatus.

7. The apparatus of claim 6, wherein the fuel source includes one or more of a natural gas source and a hydrocarbon waste source.

8. The apparatus of claim 2, further comprising at least one of:
a gas turbine power plant,
coupled to the air separation apparatus to receive N₂ therefrom, and
coupled to the H₂ separation apparatus to receive H₂ therefrom; and
a nitrogen fertilizer plant, and
coupled to the air separation apparatus to receive N₂ therefrom, and
coupled to the H₂ separation apparatus to receive H₂ therefrom.

9. The apparatus of claim 3, further comprising at least one of:
a synthetic liquid fuel plant coupled to the H₂/CO ratio adjuster to receive syngas therefrom,
a methanol plant coupled to the H₂/CO ratio adjuster to receive syngas therefrom,
an ethanol plant coupled to the H₂/CO ratio adjuster to receive syngas therefrom,
an ethylene glycol plant coupled to the H₂/CO ratio adjuster to receive syngas therefrom,
a light olefins plant coupled to the H₂/CO ratio adjuster to receive syngas therefrom, and
an acetic acid plant coupled to the H₂/CO ratio adjuster to receive syngas therefrom.

10. The apparatus of claim 1, wherein the autothermal dry reforming of methane apparatus includes an autothermal reformer, the autothermal reformer comprising a partial oxidation reactor and a catalytic reformer.

11. The apparatus of claim 10, wherein the catalytic reformer includes a nickel-based CO₂ dry reforming catalyst.

12. The apparatus of claim 1, wherein the autothermal steam reforming of methane apparatus includes an autothermal reformer, the autothermal reformer comprising a partial oxidation reactor and a catalytic reformer.

13. The apparatus of claim 12, wherein the catalytic reformer includes a nickel-based steam methane reforming catalyst.

14. A method for producing syngas, comprising:
configuring an autothermal dry reforming of methane apparatus to receive CO₂ from one or more industrial emission sources and an H₂ separation apparatus, which receives H₂ and CO₂ from a water gas shift reactor fed with syngas generated in an autothermal steam reforming of methane apparatus.
